(19) United States
(12) Patent Application Publication
(10) Pub. No.: US 2015/0222787 A1
(43) Pub. Date: Aug. 6, 2015

(54) PRINTING DEVICE AND PRINTING METHOD

(71) Applicant: Sharp Kabushiki Kaisha, Osaka (JP)

(72) Inventor: Masahiro SAKIYAMA, Osaka-shi (JP)

(21) Appl. No.: 14/608,394

(22) Filed: Jan. 29, 2015

(30) Foreign Application Priority Data
Jan. 31, 2014 (JP) 2014-017195

(51) Int. Cl. H04N 1/393; G06K 15/02; H04N 1/32; H04N 1/40

(52) U.S. Cl. CPC H04N 1/393; H04N 1/40068; G06K 15/1843; H04N 1/32144; H04N 2201/0082; H04N 2201/0093; H04N 2201/3269; H04N 2201/3271; H04N 2201/0081

(57) ABSTRACT

A printing device includes an image processor that performs image processing on an image to be printed and a printer that takes the image that has undergone the image processing from the image processor as input and prints the image. When printing of the image to be printed is executed by the printer, the image processor incorporates magnification rate information into the image to be printed or the enlarged/reduced image of the image to be printed as the image processing and outputs the resulting image including the magnification rate information to the printer.

### BACKGROUND OF THE INVENTION

1. Field of the Invention

The present invention relates to a printing device and a printing method.

2. Description of the Related Art

Conventionally, printing devices have been able to print images of documents read by document reading devices after enlarging or reducing them. For example, Japanese Patent Application Laid-Open Publication No. 2005-223833 discloses a technology in which the user inputs a magnification rate and the size of paper to be used, and the image of the document is divided based on the input magnification rate and size and then printed.

Incidentally, for printed matter that has been printed at an altered magnification of a document to be printed, such as printed matter that has been reduced or enlarged so as to fit onto paper of a specified size, there are cases in which a user wishes to return this printed matter that has been reduced or enlarged before publication to its original size (the original dimensions) in the case of creating duplicates by making secondary copies of the printed matter when copying documents including books and other publications or when printing image data from a personal computer (PC).

However, in the conventional art, including the technology described in Japanese Patent Application Laid-Open Publication No. 2005-223833, there is no way for the user to determine simply by looking at the result of printing what magnification rate was used relative to the source document to print the printed matter that was printed at an altered magnification, or for that matter, whether it was printed at an altered magnification or in the original size.

Accordingly, with the conventional art, if the user wants to obtain a print of the source document in the original size when making secondary copies of printed matter that is not in the original size, it is necessary for the user to determine the magnification rate by relying on other information and to perform a copy operation. In such cases, furthermore, the magnification rate is set manually at the time of copying, but this may sometimes require copying to be done repeatedly while changing the enlargement/reduction rate numerous times until a duplicate of suitable size is obtained.

### SUMMARY OF THE INVENTION

In light of the circumstances described above, preferred embodiments of the present invention provide a printing device and method with which it is possible to return to an original size easily when creating duplicates of printed matter.

According to a first preferred embodiment of the present invention, a printing device includes an image processor configured or programmed to perform image processing on an image to be printed and a printer that takes the image that has undergone the image processing as input from the image processor and prints the image, wherein when printing of the image to be printed is executed by the printer, the image processor incorporates magnification rate information into the image to be printed or the enlarged/reduced image of the image to be printed as the image processing and outputs it to the printer.

According to another preferred embodiment of the present invention, in a case in which the magnification rate information is incorporated into the enlarged/reduced image as the image processing, the magnification rate information is information that indicates an enlargement/reduction rate or an inverse of the enlargement/reduction rate when the magnification is changed from the image to be printed to the enlarged/reduced image.

Another preferred embodiment of the present invention further includes a settings device configured to set whether or not to print the magnification rate information based on a user operation.

According to a further preferred embodiment of the present invention, a printing device further includes a document reader configured to optically read a document image printed on a document and an information extractor configured to extract the magnification rate information from the document image read by the document reader, and when the magnification rate information is extracted by the information extractor, the image processor generates an original size image as the image processing based on the magnification rate information by changing the magnification of the document image such that it becomes the original size, and outputs it to the printer.

According to yet another preferred embodiment of the present invention, a printing device includes an image processor configured or programmed to perform image processing on an image to be printed and a printer configured to take the image that has undergone the image processing as input from the image processor and prints it, wherein the printing device further includes a document reader configured to optically read a document image printed on a document as the image to be printed and an information extractor configured to extract magnification rate information from the document image read by the document reader, and when the magnification rate information is extracted by the information extractor, the image processor generates an original size image as the image processing based on the magnification rate information by changing the magnification of the document image such that it becomes the original size, and outputs it to the printer.

According to another preferred embodiment of the present invention, the original size image is an image from which the magnification rate information has been eliminated by the image processor.

According to another preferred embodiment of the present invention, the magnification rate information is printed at a prescribed size defined in advance, and when the magnification rate information is extracted by the information extractor, the image processor generates the original size image as the image processing based on the magnification rate information and the prescribed size and outputs it to the printer.

According to another preferred embodiment of the present invention, the magnification rate information is printed as a QR code (registered trademark, the same hereinafter) or barcode.

According to another preferred embodiment of the present invention, a printing method includes an image processing step in which, when executing printing of an image to be printed, an image processor incorporates magnification rate information into the image to be printed or the enlarged/reduced image of the image to be printed, and a printing step in which a printer takes an image that has undergone processing in the image processing step as input and prints it.

According to a further preferred embodiment of the present invention, a printing method of a printing device includes a document reading step in which a document reader of the printing device optically reads a document image printed on a document, an information extraction step in which an information extractor of the printing device extracts magnification rate information from the document image read in the document reading step, an image processing step in which, when the magnification rate information is extracted in the information extraction step, an image processor of the printing device generates an original size image based on the magnification rate information by changing the magnification of the document image such that it becomes the original size, and a printing step in which a printer of the printing device takes the original size image as input and prints it.

Various preferred embodiments of the present invention make it possible to easily return to the original size when creating duplicates of printed matter.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing an exemplary configuration of the printing device according to a first preferred embodiment of the present invention.

FIG. 2 is an external appearance diagram showing one example of an operation input in the printing device of FIG. 1.

FIG. 3 is a flowchart for illustrating one example of print processing in the printing device of FIG. 1.

FIG. 4A is a diagram showing one example of a UI image that is displayed, when in copy mode, on the operation input of the printing device of FIG. 1.

FIG. 4B is a diagram showing one example of a UI image that is displayed when the magnification rate button on the UI image of FIG. 4A is touched.

FIG. 5A is a diagram showing one example of a document that constitutes an object to be copied.

FIG. 5B is a diagram showing one example of printing paper when the document of FIG. 5A is reduced and copied by the printing device of FIG. 1.

FIG. 6 is a flowchart for illustrating another example of print processing in the printing device of FIG. 1.

FIG. 7A is a diagram showing one example of a UI image that is displayed when in document filing mode on the operation input of the printing device of FIG. 1.

FIG. 7B is a diagram showing one example of a UI image that is displayed when the standard folder button on the UI image of FIG. 7A is touched.

FIG. 8 is a diagram showing one example of a UI image that is displayed when the document size has not been defined for the image to be printed in the print processing of FIG. 6.

FIG. 9 is a block diagram showing an exemplary configuration of the printing device according to a second preferred embodiment of the present invention.

FIG. 10 is a flowchart for illustrating one example of print processing in the printing device of FIG. 9.

FIG. 11 is a diagram showing one example of printing paper when the document of FIG. 5B is further reduced and copied by the printing device according to a third preferred embodiment of the present invention.

FIG. 12 is a flowchart for illustrating one example of the print processing according to a fourth preferred embodiment of the present invention.

FIG. 13 is a diagram showing one example of a UI image that is displayed on the side of a PC in the print processing of FIG. 12.

### DETAILED DESCRIPTION OF THE PREFERRED EMBODIMENTS

A printing device according to a preferred embodiment of the present invention preferably includes an image processor and a printer. Examples of the printing device according to a preferred embodiment of the present invention include multifunction peripherals (MFPs), single-function printer machines, and single-function copiers. Furthermore, examples of the printing method according to a preferred embodiment of the present invention include methods for printing on such printing devices and methods for printing from computers. Various preferred embodiments of the present invention will be described below with reference to drawings.

### First Preferred Embodiment

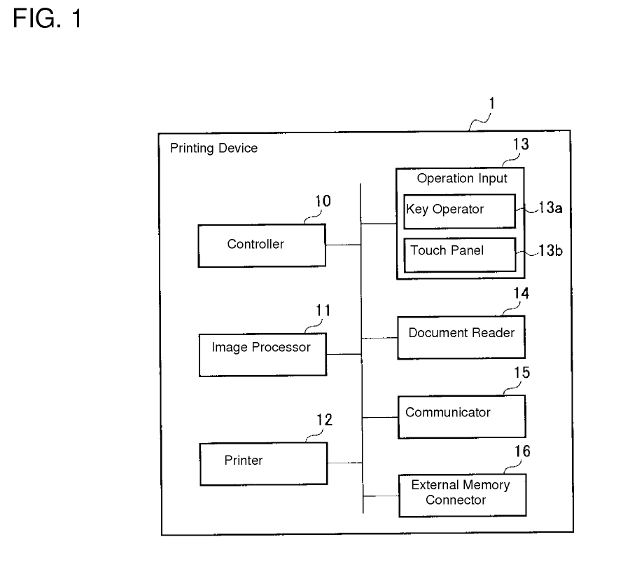

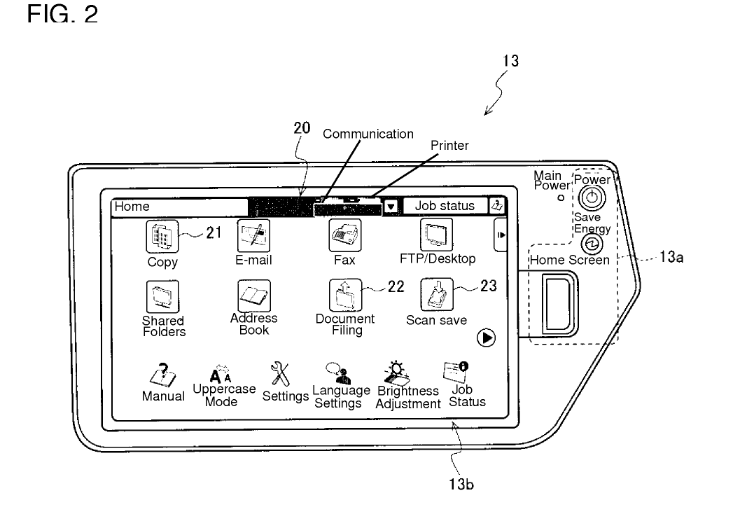

A first preferred embodiment of the present invention will be described with reference to FIGS. 1 through 8. FIG. 1 is a block diagram showing an exemplary configuration of the printing device according to the present preferred embodiment, and FIG. 2 is an external appearance diagram showing one example of the operation input in the printing device of FIG. 1.

The printing device 1 according to the present preferred embodiment preferably includes a controller 10 that is configured or programmed to control the entire device, and it also includes an image processor 11, a printer 12, an operation input 13, a document reader 14, a communicator 15, and an external memory connector 16.

The controller 10 stores in a program storage area control programs (firmware) that control the entirety of the printing device 1 and performs various types of control by making these control programs operate. The controller 10 preferably includes, for example, a central processor (CPU) or microprocessor (MP), random access memory (RAM) as a working area, and controllers such as storage devices that store the control programs described above and various settings. The controller 10 may also be configured as an integrated circuit or an IC chipset. Examples of this storage device include flash ROM (read-only memory), electrically erasable and programmable ROM (EEPROM), and hard disk drives (HDD), and it is also possible to include storage devices or memories (not shown) such as HDDs to store images.

The image processor 11 is configured or programmed to perform image processing on images to be printed. This image processing includes the magnification rate information incorporation processing according to various preferred embodiments of the present invention, which will be described later, as well as processing to convert to a format that can be printed by the printer 12 when the image to be printed that is input to the image processor 11 is not in a printable format. The image processor 11 can itself be also constituted as a controller that is made to operate by firmware, similar to the controller 10; it can also be installed as an integrated circuit/IC chipset. Moreover, the image processor 11 can be installed in the printing device 1 as an application-specific integrated circuit (ASIC).

The printer 12 is configured to take images from the image processor 11 (images that have undergone image processing) as input and prints these images on printing paper or the like. Any type of printing such as electrophotography or ink jet may be used.

The operation input 13 is configured to accept operating input from the user, and includes a key operator 13a and a touch panel 13b as shown in FIG. 2 as an example. The user can input values for settings or the like and performs processes from the operation input 13 when using the printing device 11.

The key operator 13a preferably includes hardware keys configured to accept user operations. FIG. 2 shows an example in which a power key, an energy-saving key, and a transition key to move to the home screen are provided, but the configuration is not limited to this. Other keys such as a start key to start copying and a group of number keys to enter numbers may also be provided.

The touch panel 13b includes a display such as a liquid crystal display or an organic electroluminescence display and a touch sensor that detects touch operations on the display area of the display by the user. Examples of the sensors installed as the touch sensor include electrostatic capacitive-type sensors and resistive film-type sensors.

A user interface (UI) image is displayed on the display, and when a touch is detected by the touch sensor on the displayed UI image, the processing indicated by the image within the UI image that corresponds to the touched position is executed, and the UI image is changed as needed. The UI image 20 shown in FIG. 2 is an example of the UI image displayed on the initial screen. The UI image 20 is an example of a case in which the printing device 1 is an MFP; it displays, in a manner selectable for the user, buttons to use functions provided in the printing device 1, such as a copy function select button (copy mode select button) 21, a document filing function select button (document filing mode select button) 22, and a scan save function select button (scan save mode select button) 23. Note that a configuration is also possible which enables UI image transitions and the like by pressing down hardware keys as well, such as a transition key to move to the home screen.

The document reader 14 preferably is installed on the bottom surface of the document platform on which the document (paper) to be read is placed and that is used to optically read the document image on the paper placed on the document platform and transfer it to the image processor 11. The document reader 14 is also called a scanner.

In addition, the printing device 1 may also be provided with an auto document feeder (ADF) over the document platform. The ADF is configured to automatically transport documents and the image of the automatically transported document is read by the document reader 14. Naturally, a separate document reader 14 may also be installed in the ADF. Here, a device called a single pass feeder (SPF), reverse pass feeder (RSPF), or the like is preferably included as the ADF.

The communicator 15 preferably is a wired network interface configured to communicate with an external personal computer (PC), server device, or the like. Note that a server device that uses file transfer protocol (FTP) or a protocol derived from it is an example of the server device. The printing device 1 is configured to receive print jobs from PCs using the communicator 15 and to acquire files for printing by accessing on the server device over the communicator 15.

The external memory connector 16 is a connection interface configured to connect external memory such as universal serial bus (USB, registered trademark; the same hereinafter) memory to the printing device 1. The printing device 1 is configured to acquire files stored in external memory over the external memory connector 16 to perform printing.

The printing device 1, by virtue of such a configuration, is able to print images of documents read by the document reader 14, to print images received from outside over the communicator 15 or the external memory connector 16, to read out and print images stored in the storage device or memory (not shown), and so on.

Furthermore, one of the unique features of the present preferred embodiment is that, when executing printing of the image to be printed at an altered magnification by the printer 12, the image processor 11 generates an enlarged/reduced image by changing the magnification of the image to be printed as the image processing described above and also incorporating magnification rate information that indicates the enlargement/reduction rate of the printing at an altered magnification described above into this enlarged/reduced image and outputs it to the printer 12. That is, the image processor 11 is configured to also perform magnification rate information incorporation processing as image processing in addition to magnification change processing. An enlarged/reduced image combined with magnification rate information is printed by the printer 12.

As was described above, examples of the image to be printed here include document images read by the document reader 14, images received over the communicator 15 or the external memory connector 16, and images stored in the storage device or memory (not shown). Note that the printing device 1 in the present preferred embodiment need not be equipped with some or all of the document reader 14, the communicator 15, the external communicator 16, and the storage devices described above, and it is sufficient as long as it includes at least one path by which it can obtain images to be printed. This path can be ensured, for example, by equipping it with a mobile telephone (including smart phones) or a wireless communicator configured to conduct close-proximity wireless communications.

Moreover, the printing at an altered magnification may be either enlargement printing or reduction printing. In addition, the magnification rate information is combined with the enlarged/reduced image and ultimately printed by the printer 12, so it can be combined as an image that indicates the enlargement/reduction rate (hereinafter referred to as “magnification rate image”).

Furthermore, information that indicates an inverse of the enlargement/reduction rate can also be used as the magnification rate information instead of the enlargement/reduction rate. That is, the magnification rate information may be information that indicates the magnification rate at which printing was performed, or it may be information that indicates the magnification rate needed to print to return to the original size.

Moreover, the magnification rate information is preferably printed as a QR code or barcode. The use of ordinary codes as the magnification rate information facilitates its penetration into society as an ordinary process that performs processing to incorporate magnification rate information as in the present preferred embodiment when performing printing at an altered magnification.

Besides QR codes or barcodes, text information (such as “print reduced to 0.7× (or 70%)” or “print has been reduced to 0.7× (or 70%)”), for example, can be used as the magnification rate information to be printed. In addition, QR codes or barcodes may be printed simultaneously with text information, for example. Furthermore, when incorporating text information, it is also possible to incorporate text strings that require decoding when read, similar to QR codes and barcodes, rather than limiting the enlargement/reduction rate to character strings that the user can decipher. Moreover, the magnification rate information may be printed in a color that is difficult to see, such as yellow.

In addition, it is desirable that the incorporation position for the magnification rate information be, for example, a preset position in the white margin of the printing paper, or a random position on the back of the printing paper or a preset position on the back although this is limited to single-sided printing. Doing so prevents the magnification rate information from being printed over the enlarged/reduced image, so not only does this prevent the image to be printed from being blocked out, but it also prevents detection errors in magnification rate information detection processing (described later). In particular, in cases where text information is printed as magnification rate information, it is possible to distinguish it from text groups included in the image to be printed, which therefore makes it possible to prevent recognition errors in magnification rate information detection processing.

Thus, with the present preferred embodiment, when creating duplicates of printed matter that has been printed at an altered magnification, printing is performed with magnification rate information being attached, and it is possible to have the printing device automatically read this magnification rate information when making secondary copies, so it is possible to easily return the material to its original size prior to this printing at an altered magnification. Here, if enlargement printing is performed as the printing at an altered magnification, the printed matter is capable of being returned to the original size by reducing it based on the magnification rate information that was incorporated in the print at that time. Conversely, if reduction printing is performed as the printing at an altered magnification, the printed matter is capable of being returned to the original size by enlarging it based on the magnification rate information that was incorporated in the print at that time.

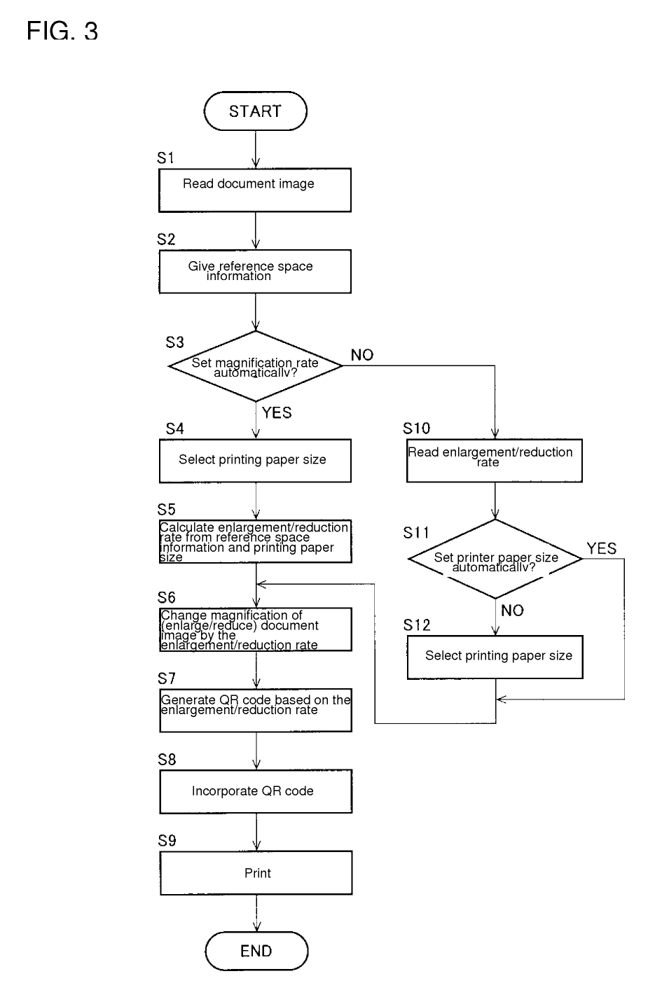

Next, a concrete example of print processing that includes magnification rate information incorporation processing according to the present preferred embodiment will be described with reference to FIGS. 3 through 5B using as an example a case in which an output from the document reader 14 is the image to be printed (i.e., the case of copying a document at an altered magnification). Here, an example of incorporating a QR code as the magnification rate information will be given, but the processes preferably are similar with other types of magnification rate information as well.

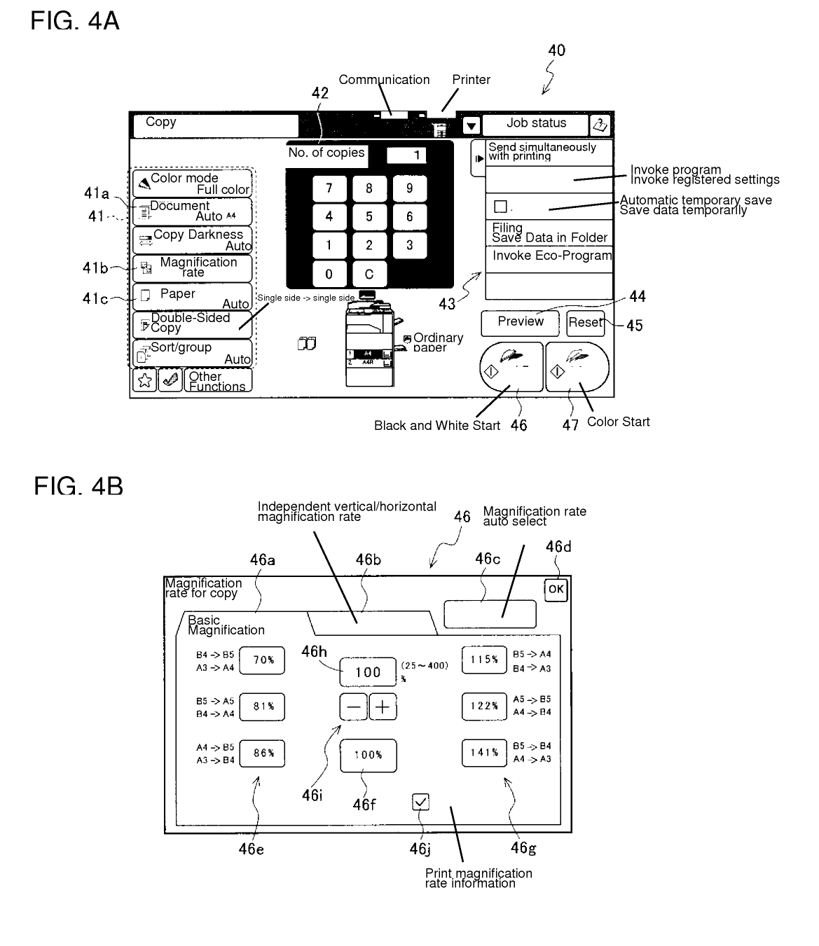

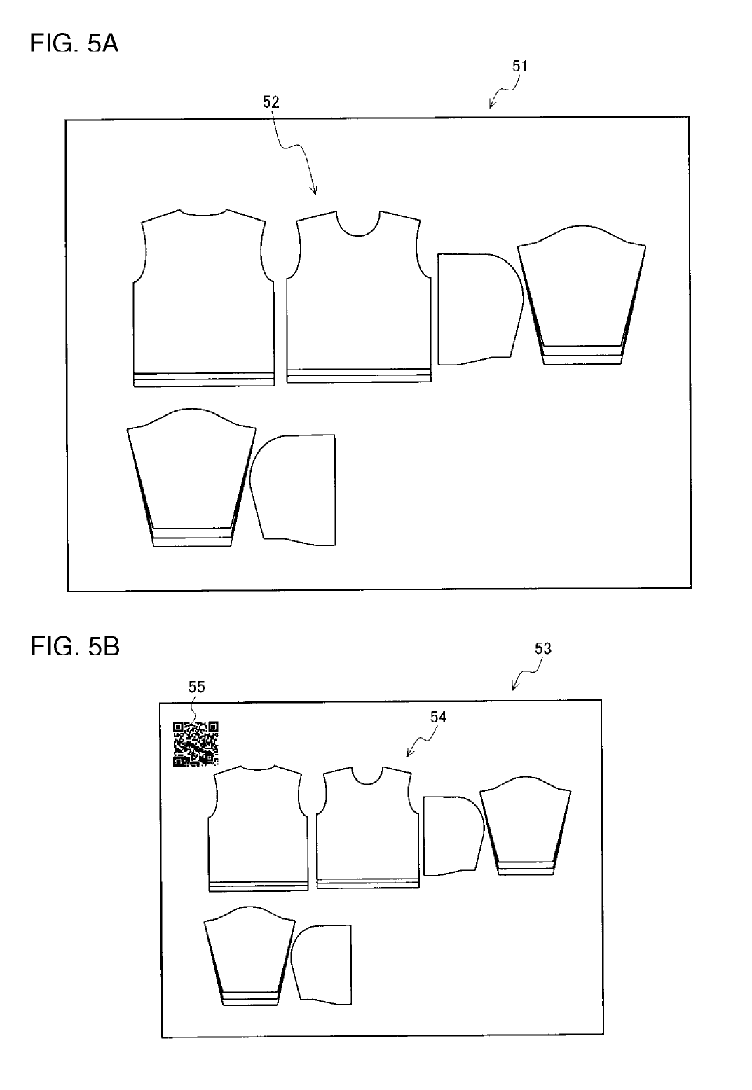

FIG. 3 is a flowchart for illustrating one example of print processing in the printing device of FIG. 1. Furthermore, FIG. 4A is a diagram showing one example of a UI image that is displayed, when in copy mode, on the operation input of the printing device of FIG. 1, and FIG. 4B is a diagram showing one example of a UI image that is displayed when the magnification rate button on the UI image of FIG. 4A is touched. Moreover, FIG. 5A is a diagram showing one example of a document that constitutes an object to be copied, FIG. 5B is a diagram showing one example of printing paper when the document of FIG. 5A is reduced and copied by the printing device of FIG. 1.

When making a copy, the user first touches the copy function select button 21 of the UI image 20 of FIG. 2. Upon this touch, a UI image 40 for copy mode as shown as an example in FIG. 4A is displayed. In addition to the settings button group 41, a number-of-copies input field 42 to enter the number of copies to be printed, an operation specification button group 43 including a plurality of buttons to specify various types of operation, a preview display button 44 to display a preview image prior to printing, a reset button 45 to reset all settings, a black-and-white start button 46 to start black-and-white copying, a color start button 47 to start color copying, and the like are displayed in the UI image 40.

The settings button group 41 includes a document setup button 41a to perform setup relating to document size and type, a magnification rate setting button 41b to set the magnification rate of the copies, a paper setup button 41c to perform setup relating to paper size and type, and the like.

In the case of performing magnification change processing when copying as in the present preferred embodiment, the user touches the magnification rate setting button 41b, for example. Upon acceptance of this touch, the touch panel 13b displays a UI image 46 to set the magnification rate as shown as an example in FIG. 4B, instead of the UI image 40, or as a pop-up image superimposed on the UI image 40.

A basic magnification rate tab 46a to set the magnification rate when printing at the same vertical and horizontal magnification rates (referred to hereinafter as the “basic magnification rate”) is displayed in the UI image 46. When display of the UI image 46 commences, or when the user touches the basic magnification rate tab 46a from a different status, the setting of the basic magnification rate is enabled. A button group 46e to select the enlargement/reduction rate when reducing at a prescribed value, a button group 46g to select the enlargement/reduction rate when enlarging at a prescribed value, and a 100% button to use 100% (i.e., leaving the magnification unchanged) are displayed in the basic magnification rate tab 46a. In addition, an enlargement/reduction rate display field 46h and zoom buttons 46i, which are composed of −/+ buttons to zoom in the reduction/enlargement direction from the enlargement/reduction rate displayed in the enlargement/reduction rate display field 46h and also to change the enlargement/reduction rate displayed in the enlargement/reduction rate display field 46h, are displayed in the basic magnification rate tab 46a. The user sets the basic magnification rate using these buttons.

An independent vertical/horizontal magnification rate tab 46b to set the magnification rate when printing at different vertical and horizontal magnification rates (referred to hereinafter as “independent vertical/horizontal magnification rates”) and a magnification rate auto-select button 46c to automatically select the magnification rate are also displayed in the UI image 46.

When the magnification rate auto-select button 46c is touched and then an OK button 46d (described below) is touched, the enlargement/reduction ratio is determined based on the printing paper size and the size of the document image read by the document reader 14 or the size of the document image set by the user in the UI image for setup that is displayed as a result of the document setup button 41a being touched. Here, the printing paper size is the size of printing paper set by the user from the UI image for setup that is displayed by a touch on the paper setup button 41c. When the magnification rate auto-select button 46c is touched, the device is set up so as to select the magnification rate automatically. In this setting, it is assumed that the magnification rate is automatically set, basically presuming that magnification rates are the same for vertical and horizontal.

Furthermore, the UI image 46 also displays the OK button 46d to save the settings at the time of touch into the memory or the like within the controller 10 and closing the UI image 46 to complete the setup. As a result of the user setting the enlargement/reduction rate from either the basic magnification rate tab 46a, the independent vertical/horizontal magnification rate tab 46b, or the magnification rate auto-select button 46c and then touching the OK button 46d, these settings are relayed to the controller 10, and the UI image 46 is closed to return to the UI image 40.

Moreover, in the present preferred embodiment, a checkbox 46j that selects whether or not to print the magnification rate information is provided in the basic magnification rate tab 46a. When the user touches this checkbox 46j and completes the setup in a state in which the check is entered, the magnification rate information is printed when printing is executed. Naturally, it is preferable that the option of whether or not to print the magnification rate information be selectable by the user when setting independent vertical/horizontal magnification rates and when selecting the magnification rate automatically as well.

As shown in the example in FIG. 4B, the printing device 1 is preferably equipped with a setter configured to set whether or not to print the magnification rate information based on user operations. An example of the setter is shown by the operation input 13 and the controller 10 in FIG. 1 and its settings may be stored in the controller 10 and referenced when executing. In addition, it is also possible to have settings made with this setter executed based on user operations to select either a mode that prints magnification rate information or a mode that does not print magnification rate information. For example, a copy function select button with magnification rate information to execute copies with the magnification rate information being printed may be displayed on the UI image 20 together with the copy function select button 21.

Furthermore, it is also possible to devise the setter described above such that even among cases in which magnification rate information is to be printed, the user can set up the type of magnification rate information such as printing QR codes, printing barcodes, or printing text information. Additionally, the color and position of the magnification rate information may also be rendered settable by the user with the setter described above.

After the magnification rate setting operations and the like have been completed in this manner and the display has returned to the UI image 40, the copy start operation is relayed to the controller 10 by the user touching the black-and-white start button 46 or the color start button 47. The document may be placed on the document platform or in the ADF prior to performing the magnification rate setting operation or the like (or after performing the magnification rate setting operation or the like). In this processing example, a description will be given with a document 51 on which a clothing pattern 52 is drawn as the object to be copied.

When the controller 10 receives a copy start operation, it controls the various components according to the processing procedure shown as an example in FIG. 3 and makes printing execute. First, the document reader 14 optically reads the document image printed on the document 51 as the image to be printed according to the controls of the controller 10 (step S1).

Next, the controller 10 provides the reference space information to this document image (step S2). “Reference space information” refers to information that serves as a reference to define the size of the document that is to be read (document size) and is information that indicates the space (distance) per pixel each in the vertical direction and in the horizontal direction. For example, it is given according to the content set by the document setup button 41a in the UI image 40 or according to the result of automatically determining the document size. When the image to be printed is an image to be printed that is read by the document reader 14 as in this processing example, it will have a space that is basically the same in the vertical and horizontal directions. This reference space information has the same meaning as the reading resolution in the document reader 14, which may be expressed as 400 dpi or the like, for example.

The controller 10 determines whether or not the magnification rate auto-select button 46c has been selected, that is, whether or not the enlargement/reduction rate is to be set automatically (step S3). In the case of YES in step S3, the controller 10 instructs the touch panel 13b to display the UI image (the UI image that is displayed by touching the paper setup button 41c) which prompts the user to select a printing paper size and lets the user make a selection (step S4). Naturally, the printing paper size can also be preset before the copy start operation, in which case, these settings may be read out in step S4.

Next, the controller 10 calculates the enlargement/reduction rate from the reference space information and the printing paper size (step S5) and instructs the image processor 11 to generate an enlarged/reduced image obtained by changing the magnification of (enlarging/reducing) the document image at this enlargement/reduction rate (step S6) while also reading out the magnification rate information (a QR code is shown as an example) based on this enlargement/reduction rate or generating it freshly (step S7) and incorporating this QR code into the enlarged/reduced image (step S8). Note that the order of the processing of step S6 and the processing of S7 does not matter. Moreover, the magnification rate information can also be incorporated by steps S7 and S8 before the magnification change processing of step S6, and the magnification change processing executed thereafter. In this case, however, the magnification rate information preferably is incorporated at a size that also factors in this magnification change processing.

In addition, the enlarged/reduced image after incorporation is sent to the printer 12 from the image processor upon instructions from the controller 10. Finally, the controller 10 instructs the printer 12 to print this enlarged/reduced image after the incorporation (step S9) and ends the processing.

When the document 51 of the FIG. 5A is copied at 70%, for example, a printed matter (duplicate) 53 shown by FIG. 5B is output. A reduced image 54 that reduces the pattern 52 to 70% is printed on the printed matter 53 together with a QR code 55. As a result of such a printing process, when the user wants to copy a clothing pattern published in a book, for example, in the original size in order to use it, if there is a QR code that contains the magnification rate information (i.e., the reduction rate information) that was printed together with the pattern, then an original size pattern is capable of printed by automatically determining the appropriate magnification rate based on this QR code and printing without the user having to specify a magnification rate.

In the case of NO in step S3, on the other hand, the controller 10 reads out the preset enlargement/reduction rate from the basic magnification rate tab 46a (step S10). Note that if the rate has not been preset by the user, a UI image (an image such as the UI image 46 of FIG. 4B) prompting the user to input an enlargement/reduction rate may be displayed at this time to have the user set the rate.

After step S10, the controller 10 determines whether or not the printing paper size is automatically set (step S11). This automatic setting is capable of being set by a user operation from the UI image for setup that is displayed as a result of the paper setup button 41c being touched, for example. In the case of NO in step S11, the controller 10 selects a printing paper size in the same manner as in step S4 (step S12) and advances to step S6. In the case of YES in step S11, the procedure advances directly to step S6.

Processing from step S6 and beyond is the same as described above, and printed matter containing the QR code 55 such as the printed matter 53, for example, is capable of being output in the same manner.

Furthermore, an ordinary preview image may also be displayed immediately before step S3, immediately after step S6, immediately after step S8, and so on, so as to enable the user to change settings.

Moreover, when the printed matter 53 is generated by copying a document with a QR code being added as in this processing example, processing involving specifically how to return to original size will be described later as second and third preferred embodiments.

In addition, when the printing paper size is set manually, selection of a printing paper size that will execute so-called “poster printing” may also be enabled both when the magnification rate is set automatically and when the magnification rate is set manually. “Poster printing” here refers to printing that prints a single document image divided onto a plurality of sheets of printing paper. When the magnification rate information such as a QR code is printed during poster printing, it is only necessary to print the magnification rate information on all the printed matter and to have this magnification rate information include information that indicates positions to line up the plurality of sheets of printed matter, such as branch numbers, that indicates the respective position order of the printed matter (in other words, information that indicates how to position images read from the printed matter when returning to the original size to assemble the original size image).

Conversely, poster printing may also be prohibited when printing magnification rate information, in which case it is only necessary to make printing paper sizes that are required for poster printing unselectable and also to output messages when setting the magnification rate manually such as, “If you set an enlargement/reduction rate larger than this, the print will not fit on a single sheet of paper. Please set to a printing paper size that will fit on one sheet.”

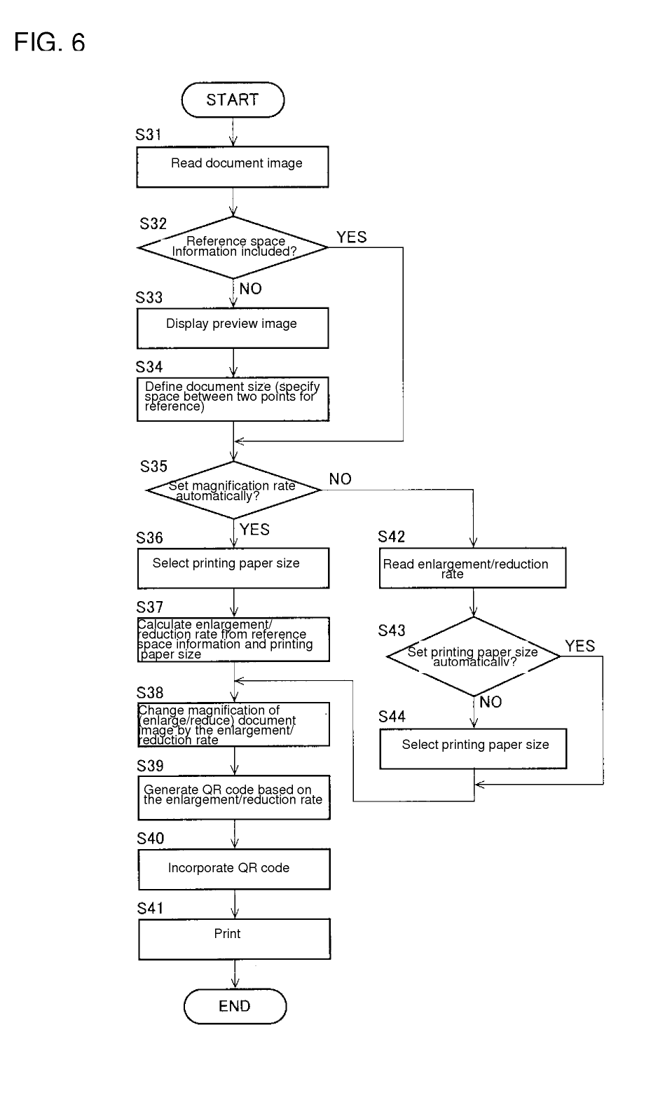

Next, another concrete example of print processing that includes the magnification rate information incorporation processing according to the present preferred embodiment will be described with reference to FIGS. 6 through 8 together using as an example the case of printing at an altered magnification of an image to be printed (file to be printed) that is received from the outside over the communicator 15 or the external memory connector 16 or stored internally. Here again, an example will be given in which a QR code is incorporated as the magnification rate information, but the processes are similar with other types of magnification rate information as well.

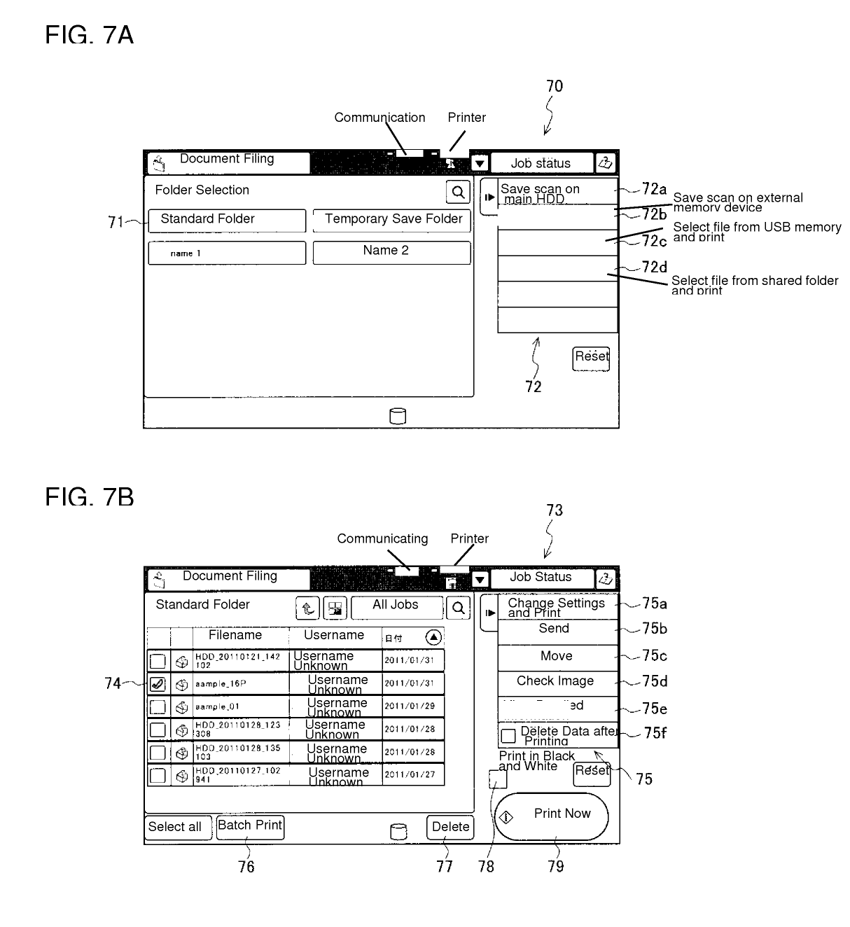

FIG. 6 is a flowchart for illustrating another example of print processing in the printing device of FIG. 1. Furthermore, FIG. 7A is a diagram showing one example of a UI image that is displayed when in document filing mode on the operation input of the printing device of FIG. 1, and FIG. 7B is a diagram showing one example of a UI image that is displayed when the standard folder button on the UI image of FIG. 7A is touched. Moreover, FIG. 8 is a diagram showing one example of a UI image that is displayed when the document size has not been defined for the image to be printed in the print processing of FIG. 6.

When an existing image for printing is to be printed, the user first touches the document filing function select button 22 on the UI image 20 of FIG. 2, for example. Upon this touch, a UI image 70 for document filing mode as shown as an example in FIG. 7A is displayed. In addition to a folder select button group which includes a standard folder select button 71, an operation specification button group 72 or the like which includes a plurality of buttons to specify various types of operation is displayed in the UI image 70.

In this example, the operation specification button group 72 includes a button 72a to save scanned images on the main HDD, a button 72b to save scanned images in external memory such as USB memory, a button 72c to select files from USB memory and printing them, and a button 72d to select files from shared folders on PCs and servers and printing them. Note that the buttons 72a and 72b are configured to perform processing that acquires scanned images from an HDD or USB memory, and the image acquired by these processes can also be used as the image to be printed in this processing example.

A description will be given below using the case of printing a file in a standard folder on the main HDD as an example, but the basic processing is the same even if the file is in a USB memory or on a server, with only the fetch destination from the printing device 1 being different. Note that, when receiving a printing job from a PC over the communicator 15 and printing it, the processing will be different, so this will be described later as a fourth preferred embodiment of the present invention.

First, the user touches the standard folder select button 71 from the UI image 70 to display the UI image 73 shown in FIG. 7B as an example. The UI image 73 displays a list of files within the standard folder described above, which includes the file “aample_{—}16P,” as well as an operation specification button group 75 including a plurality of buttons to specify various types of operation, a batch printing button 76 to execute batch printing of selected files, a delete button 77 to delete selected files, a checkbox 78 that is selected when printing in black and white, a print button 79 to execute printing, and the like.

In this example, the operation specification button group 75 includes a button 75a to change settings and printing selected files, a button 75b to send selected files externally, a button 75c to move the storage location of selected files, and a button 75d to check the images of selected files (basically differs from preview images in that they do not reflect printing settings although they may be the same in some cases). In addition, the operation specification button group 75 also includes a button 75e to view detailed information (so-called “properties”) of selected files and a checkbox 75f to delete the data of the file after printing.

Next, the user selects the checkbox 74 located to the left of the file “aample_{—}16P,” for example, from the UI image 73. The file to be printed is thus capable of being selected. After selection of the file to be printed and the like have been completed in this manner, the printing start operation is relayed to the controller 10 by the user touching the print button 79 (or the batch print button 76).

Upon receipt of the printing start operation, the controller 10 controls the various components according to the processing procedure shown as an example in FIG. 6 and makes printing execute. First, the image processor 11 is caused to acquire the file “aample_{—}16P” as the image to be printed according to the controls of the controller 10 (step S31).

Next, the controller 10 determines whether or not this file includes reference space information (step S32). Photo files, for example, have information such as pixel count for vertical and horizontal but often do not have this reference space information that defines document size. Furthermore, Microsoft Excel (registered trademark) and the like do not have reference space information, either.

If there is reference space information (in the case of YES in step S32), the controller 10 advances to step S35 and performs the same processing as in steps S3 through S12 of FIG. 3 (steps S35 through S44). Note that steps S35 through S44 can be described by simply substituting the word “copy” with “printing” in the description of steps S3 through S12. Furthermore, an ordinary preview image that does not include a ruler image 82, magnification change buttons 83 and 84, and the like (which will be described below) may also be displayed immediately before step S35, immediately after step S38, immediately after step S40, and so on, so as to enable the user to change settings.

Consequently, an enlarged/reduced image in which the magnification of the image of the file “aample_{—}16P” displayed in preview in a preview image 81 has been changed by the enlargement/reduction rate determined in step S37 or step S42 from the image of the reference space information (document size) contained in this file is generated and then combined with magnification rate information such as a QR code that indicates this enlargement/reduction rate, and printed matter is output.

Meanwhile, if there is no reference space information (in the case of NO in step S32), the controller 10 instructs the touch panel 13b to display the preview image 81 as in the UI image 80 shown as an example in FIG. 8 (step S33). A checkbox to specify whether or not to print the magnification rate information similar to the checkbox 46j of FIG. 4B is displayed in this UI image 80 in order to have the user specify the document size.

Moreover, the UI image 80 includes the ruler image 82 that indicates a scale at a position near the preview image 81 or superimposed on the preview image 81 and also displays the magnification change button 83 to change the magnification of the ruler itself, the magnification change button 84 to change the magnification of the document image itself, a rotation display button 85 to display the preview image 81 after causing the display to rotate 90° to the right or left, a display switching button 86 to switch between 1-page display, thumbnail display, or 3-D display, a black-and-white start button 87 to start black-and-white printing, a color start button 88 to start color printing, and the like. Both the magnification change buttons 83 and 84 have − buttons for reduction and + buttons for enlargement.

After step S33, the user determines the document size (the space between two points that serves as a reference) by changing the ratio between the preview image 81 and the ruler image 82 while touching the preview image 81 or the ruler image and the +/− buttons of the respective magnification change buttons 84 or 83. The controller 10 defines the document size by inputting the result of this change (step S34). This document size is adopted as the reference space information described above (for example, 400 dpi or the like). Note that the user can also determine the ratio by manipulating both rather than just one of the magnification change buttons 83 and 84. Naturally, even if one or the other of the magnification change buttons 83 and 84 is not installed, it is possible to change the ratio and to determine the document size.

In addition, instead of the ruler image 82, a frame that corresponds to a preset printing paper size may be displayed so as to be superimposed on the preview image 81. If the printing paper size has been selected at this point, it is preferable that this frame be a size that corresponds to this selected printing paper size. If the size of such a frame is designed to be changeable using +/− buttons such as those of the magnification change button 83, the ratio is capable of being changed in the same manner as when the ruler image 82 is displayed, and the document size is determined.

After the controller 10 has obtained the reference space information in this manner, it waits for the touch of the black-and-white start button 87 or the color start button 88. When the touch is performed, it advances to step S35 and performs processing similar to steps S3 through S12 of FIG. 3 (steps S35 through S44). Furthermore, a normal preview image which does not contain the ruler image 82, the magnification change buttons 83 and 84, and the like may also be displayed immediately after step S38, immediately after step S40, and so on, so as to enable the user to change settings.

By doing this, an enlarged/reduced image is generated in which the magnification of the image of the file “aample_{—}16P” displayed in preview in the preview image 81 has been changed by the enlargement/reduction rate determined in step S37 or step S42 from the image of the document size indicated as a ratio to the ruler image 82 in the UI image 80, and magnification rate information such as a QR code that indicates this enlargement/reduction rate is further incorporated, after which printed matter is output.

Moreover, the processing example of FIG. 6 does not contain processing that pertains to document reading, so it can be processed by printer machines that only have printing functions. Note that processing involving specifically how to return to the original size when generating the printed matter generated by this processing example will be described later as the second and third preferred embodiments of the present invention.

### Second Preferred Embodiment

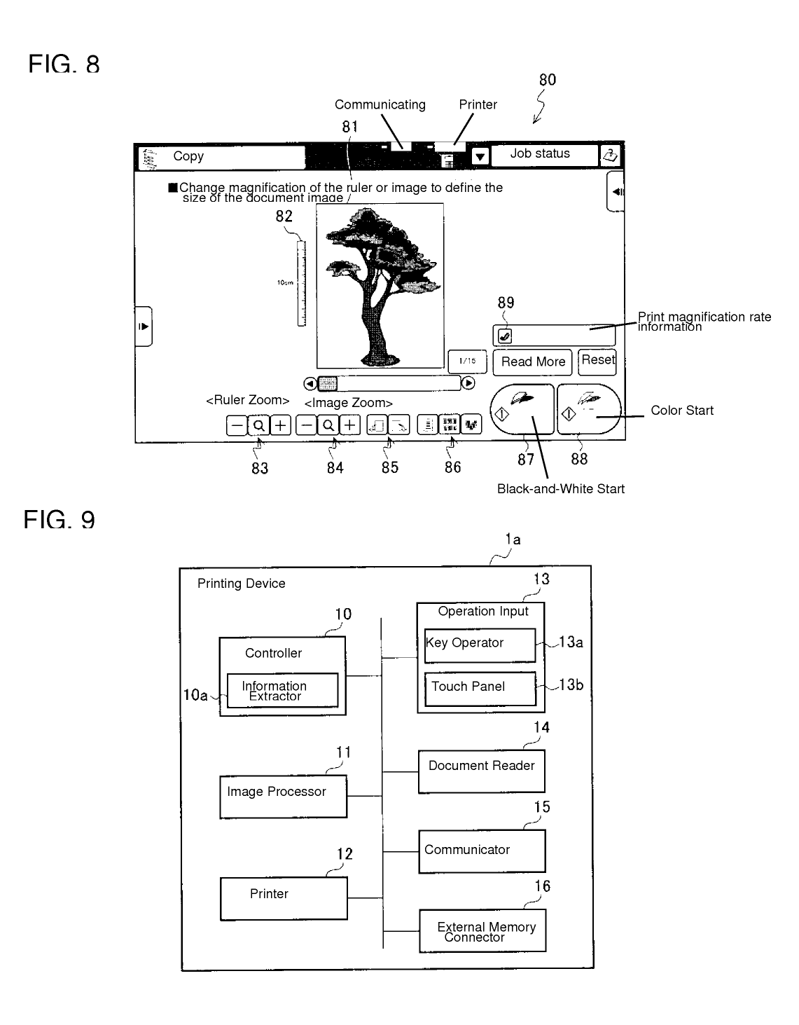

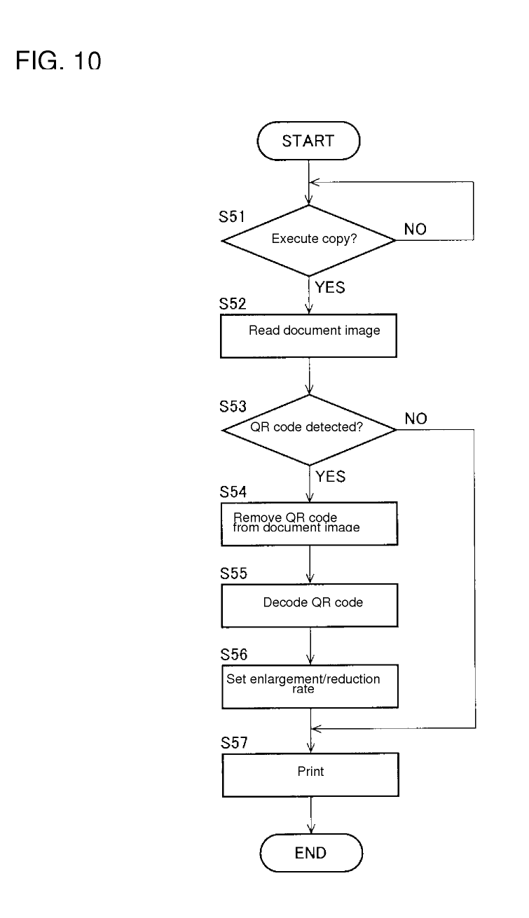

A second preferred embodiment of the present invention will be described with reference to FIGS. 9 and 10. FIG. 9 is a block diagram showing an exemplary configuration of the printing device according to the present preferred embodiment, and FIG. 10 is a flowchart for illustrating one example of print processing in the printing device of FIG. 9. The present preferred embodiment will be described by mainly focusing on the differences from the first preferred embodiment, but the various application examples described in the first preferred embodiment can also be similarly applied. However, with the printing device according to the present preferred embodiment, a document reader is required.

The printing device 1a according to the present preferred embodiment is the printing device 1 according to the first preferred embodiment constituted so as to be able to return generated printed matter to its original size. Of course, this printing device that generates printed matter and the printing device that performs processing to return to original size, however, may be devices that are installed in different locations.

As shown in FIG. 9, the printing device 1a in the present preferred embodiment preferably includes an image processor 11, a printer 12, and a document reader 14, and also equipped with an information extractor 10a. The document reader 14, as described with FIG. 1, optically reads document images printed on documents. In the present preferred embodiment, however, it is assumed that printed matter that already has magnification rate information incorporated is the object of reading as the document described above.

The information extractor 10a is configured to extract magnification rate information from the document image read by the document reader 14. In this example, information extractor 10a preferably is included in the controller 10, for example. The information extractor 10a, however, can also be installed inside the image processor 11, for example.

When the magnification rate information is extracted by the information extractor 10a, the image processor 11 in the present preferred embodiment generates an original size image by changing the magnification of the document image as the image processing based on the extracted magnification rate information so as to make it (so as to return it to) the original size (the size prior to the change in magnification) of the document that served as the source (referred to as the “source document”) when it was printed with the magnification rate information being incorporated, and the original size image is then output to the printer.

In actuality, the enlargement/reduction rate when generating the original size image may be determined by the controller 10 based on the magnification rate information extracted by the information extractor 10a. For example, if the enlargement/reduction rate is contained in the magnification rate information, it may be determined by calculating the inverse of this enlargement/reduction rate, or if the inverse is already included, then by reading this inverse. Thus, the printing device 1 is able to ascertain the original size from the image that is read, and thus is includes an image determiner.

In addition, the original size image described above is preferably an image from which the magnification rate information has been eliminated by the image processor 11. That is, the image processor 11 preferably eliminates the magnification rate information and then generates the original size image described above. Here, the image processor 11 may create an original size image by performing magnification change processing after eliminating the magnification rate information from the document image read by the document reader 14, or it may create an original size image by changing the magnification of the document image read by the document reader 14 and then eliminating the magnification rate information portion.

Thus, with the present preferred embodiment, when creating duplicates of printed matter that was printed at an altered magnification, the magnification rate information printed in combination is deciphered, and magnification change processing is then executed automatically based on this magnification rate information, so it is possible to easily return the image to its original size prior to this printing at an altered magnification. This can be utilized advantageously when creating a pattern to be actually used from a clothing pattern printed in a book, for example.

Next, a concrete example of the print processing according to the present preferred embodiment will be described with reference to FIG. 10 using as an example the case of making a copy after returning printed matter printed at an altered magnification (the printed matter 53 in FIG. 5B shown as an example) to its original size. Here, as the printed matter 53, an example of incorporating a QR code will be given, but the processes are similar with other types of magnification rate information as well.

When making a copy of the printed matter 53, the user first touches the copy function select button 21 of the UI image 20 in FIG. 2 to display the UI image 40 for copy mode as shown as an example in FIG. 4A. Thereafter, the copy start operation is relayed to the controller 10 by the user touching the black-and-white start button 46 or the color start button 47. The printed matter 53 that serves as the document may be placed on the document platform or the ADF prior to this touch.

The controller 10 controls the various components according to the processing procedure shown as an example in FIG. 10 and makes printing execute. First, the controller 10 ascertains whether or not a copy start operation has been received (step S51); at the point at which the answer becomes YES, it instructs the document reader 14 to optically read the document image of the printed matter 53 (step S52).

Next, the information extractor 10a of the controller performs extraction processing (retrieval processing) to extract the QR code from this document image read by the document reader 14 and ascertains whether or not a QR code was detected (step S53). In the case of NO in step S53, it performs print processing as normal (step S57), and processing terminates.

In the case of YES in step S53, the controller 10 instructs the document reader 14 to relay this document image to the image processor 11, while also passing the QR code or the position of the QR code in the document image to the image processor 11 and instructing the image processor 11 to remove the QR code from the document image (step S54).

Next, the information extractor 10a decodes the QR code and sets the enlargement/reduction rate for the current copying based on the enlargement/reduction rate shown in the decoding results or the inverse of the enlargement/reduction rate (step S56). In the case of the printed matter 53, the document 51 was reduced to 0.7× (70%), so it is set for enlargement to 1.41× (141%) in step S56.

After step S56, the controller 10 instructs the image processor 11 to send the document image from which the QR code has been removed to the printer 12 and also instructs the printer 12 to print this post-removal document image (step S57), and the procedure ends. In step S57, the printing paper size that is able to print the original size image is basically determined automatically, and printing paper of this size is automatically selected. However, there are also cases in which the user may wish to output printed matter of the original size image leaving a white margin as long as the original pattern 52 is original size, so the printing paper is rendered selectable by the user.

Furthermore, in FIG. 10, the order of the processing of step S54 and the processing of steps S55 and S56 does not matter. Moreover, for the production of the original size image for printing in step S57, the removal of the QR code may occur before magnification change processing or after magnification change processing as described above.

In addition, an ordinary preview image may also be displayed immediately before step S57 or the like so as to enable the user to change settings.

As a result of the above process, the document 51 on which is drawn the clothing pattern 52 as shown in FIG. 5A is output as printed matter. The printing device 1a detects the QR code and decodes it, so the user does not have to be aware of the magnification rate information required to make the image original size. Note that, as was described for the case of NO in step S53, the normal copy process may be executed when the magnification rate information is not extracted.

This processing example was described assuming that the original size image was generated unconditionally when there was magnification change information such as a QR code. However, it is also possible, for example, to display in the UI image 40 or the UI image 46 a checkbox to perform original size copying and to execute original size printing only when a check is placed in this checkbox.

Specifically, the printing device 1a is preferably equipped with another setter, based on user operations, whether to execute original size printing based on the magnification rate information or to execute ordinary printing. An example of this setter is shown by the operation input 13 and the controller 10 in FIG. 1. The settings themselves may be stored in the controller 10 and referenced when executing. Furthermore, settings made at the other setters described above may also be made to execute based on user operations that select either a mode that executes original size printing or a mode that executes ordinary printing. For instance, it is also possible to separately install an original size copy function select button to perform printing in the original size in the UI image in addition to the copy function select button 21 and to execute original size printing only when this button is selected.

### Third Preferred Embodiment

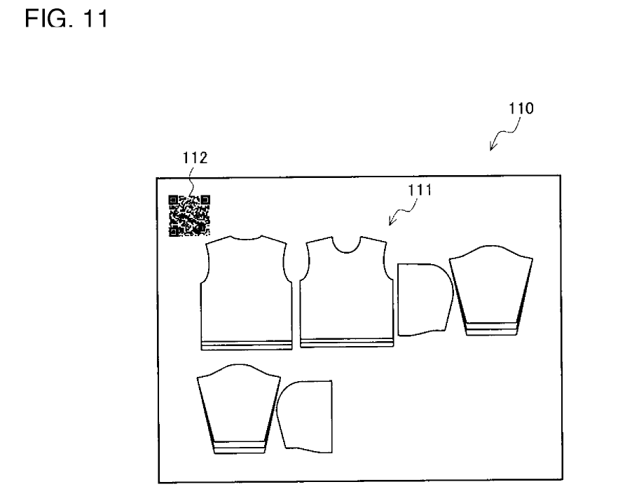

A third preferred embodiment of the present invention will be described with reference to FIG. 11. FIG. 11 is a diagram showing one example of printing paper when the document of FIG. 5B (printed matter 53) is further reduced (reduced to 0.86× as an example) and copied by the printing device according to the present preferred embodiment. The present preferred embodiment will be described by mainly focusing on the differences from the second preferred embodiment, but the various application examples described in the second preferred embodiment can also be similarly applied.

In the present preferred embodiment, a description will be given of processing to return to original size in cases where the printed matter 53 of FIG. 5B is further copied at an altered magnification. When the printed matter 53 is further copied at an altered magnification in the printing device 1a, the document image is read in the same way as in step S52 of FIG. 10, and the user sets the enlargement/reduction rate before or after this. The printing device 1a executes printing at an altered magnification based on this enlargement/reduction rate that the user has set while leaving the QR code without removing it (the processing to extract the QR code itself is also unnecessary).

A printed matter 110 such as that shown as an example in FIG. 11 is thus output when the printed matter 53 of FIG. 5B is copied while reducing it to 0.86×, for example. A reduced QR code 112 which reduces the QR code 55 to 86% is printed on the printed matter 110 together with a reduced image 111 which further reduces to 86% the reduced image 54 that reduced the pattern 52 to 70%.

The document image of such a printed matter 110 is read in step S52 by the printing device 1a according to the present preferred embodiment. In this case, the information extractor 10a must consider the degree of change in magnification (the degree of reduction in this case) for the reduced QR code 112 decoded in step S55 in the settings processing of step S56.

In this example, the size of the reduced QR code 112 is compared to the size of the QR code when printing with the printing device 1 of FIG. 1, it is detected that the code was reduced to 0.86×, and this rate is multiplied by the information included in the reduced QR code 112 itself (the information “0.70×”), thus determining that the printed matter 110 was reduced to 0.60× of the original size. Ultimately, the information extractor 10a calculates that 1.66× is required as the enlargement/reduction rate in order to achieve an original size image and sets the enlargement/reduction rate to 1.66× in step S56.

Moreover, when the information extractor 10a extracts the magnification rate information, the image processor 11 according to the present preferred embodiment generates an original size image as the image processing based on the magnification rate information and prescribed size by changing the magnification of the document image such that it becomes the original size of the source document that served as the source when printed incorporating the magnification rate information, and this original size image is then output to the printer 12. Such a process makes it possible to restore the document 51 of FIG. 5A from the printed matter 110 of FIG. 11.

As was described above, however, this presumes that the magnification rate information is printed at a prescribed size defined in advance, that is, that the image processor 11 incorporates an image of a size defined in advance as the magnification rate information when printing is performed at an altered magnification with the magnification rate information being incorporated.

In addition, in the present preferred embodiment, it may sometimes be difficult to ascertain the printing range (size) of the magnification rate information due to blurring caused by reduction when this magnification rate information is printed in something with a tight background pattern, so the present preferred embodiment is advantageous when magnification rate information is drawn in a rectangular region, as with a QR code or barcode.

### Fourth Preferred Embodiment

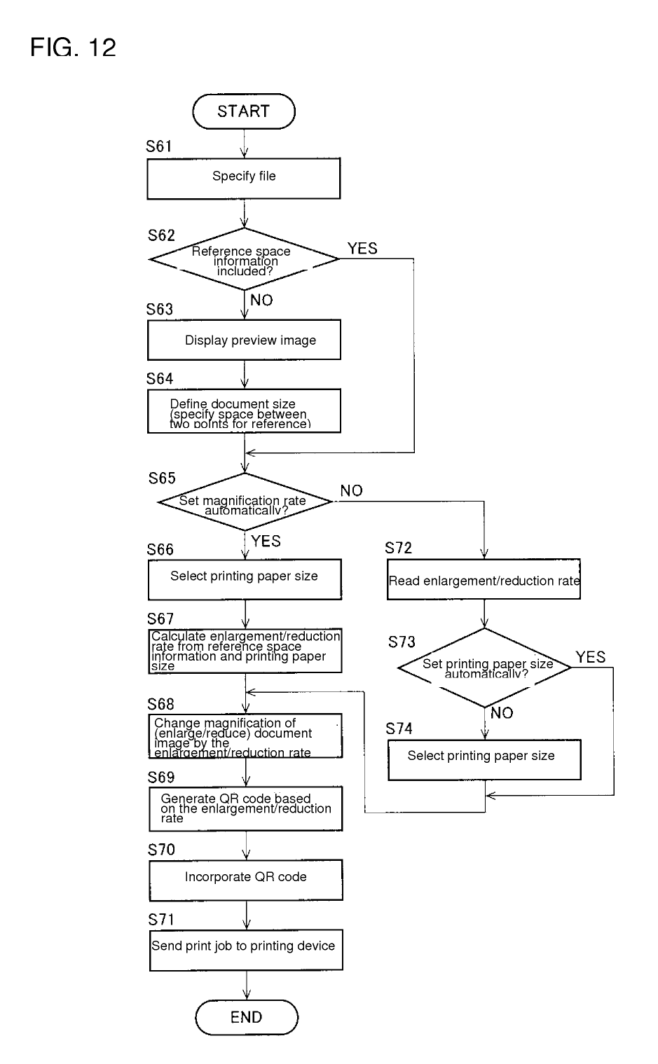

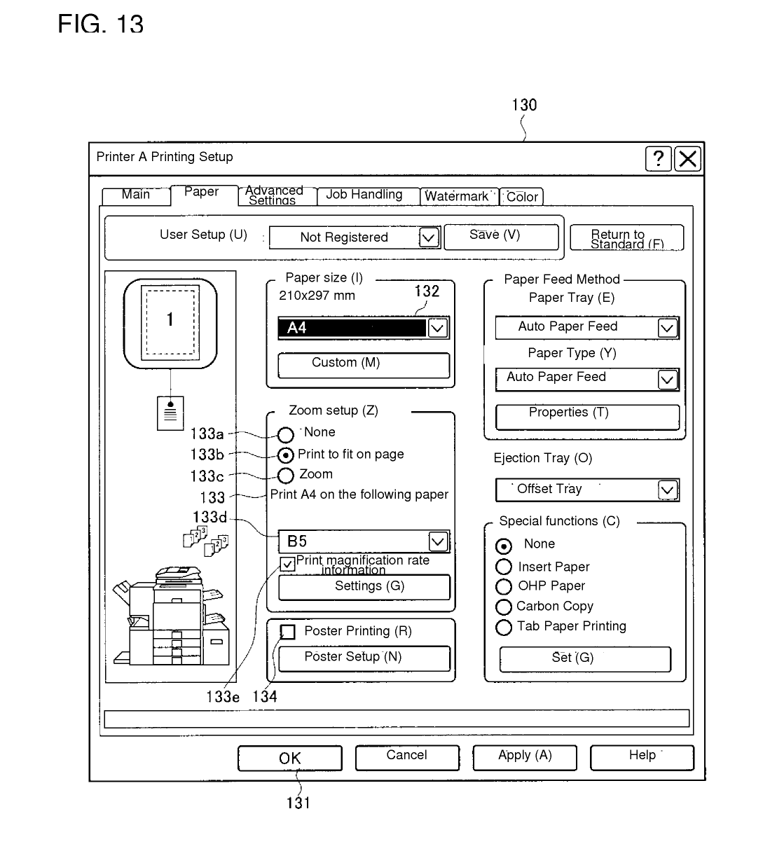

A fourth preferred embodiment of the present invention will be described with reference to FIGS. 12 and 13. FIG. 12 is a flowchart for illustrating one example of the print processing according to the fourth preferred embodiment of the present invention, and FIG. 13 is a diagram showing one example of a UI image that is displayed on the side of a PC in the print processing of FIG. 12. The present preferred embodiment will be described by mainly focusing on the differences from the first preferred embodiment, but the various application examples described in the first preferred embodiment can also be similarly applied. However, because the image to be printed is a file in the present preferred embodiment, it is possible to apply the example of acquiring the document image as in the processing example of FIG. 6, rather than the example of performing the document reading processing as in the processing example of FIG. 3.

The printing device 1 according to the present preferred embodiment performs the print processing that receives a print job from a computer (hereinafter “PC”) over the communicator 15 and prints it. Because of this, it is assumed that a printer driver for the printing device 1 is installed on the PC side.

This printer driver is a program to execute the following image processing step and printing instruction step on a PC. In the image processing step, in cases where printing of the image to be printed is executed at an altered magnification (at the time of execution), an enlarged/reduced image is generated by changing the magnification of the image to be printed, and the enlarged/reduced image is also combined with magnification rate information that indicates the enlargement/reduction rate (or the inverse of the enlargement/reduction rate) of this printing at an altered magnification. In the printing instruction step, the image processed in the image processing step is instructed to be printed. The printing device 1 executes the printing according to this instruction. In the printing device 1 in this example, however, print jobs that incorporate magnification rate information are printed, so the processing to incorporate magnification rate information and the like as described with FIG. 1 is unnecessary, and printing is capable of being handled by ordinary printing devices.

Next, such a print processing will be described with reference to FIG. 12 as well. Here again, an example of incorporating a QR code as the magnification rate information will be given, but the processes are similar with other types of magnification rate information as well.

When a given application file open on a PC is to be printed at an altered magnification, the user proceeds to printing setup processing, for example, by selecting a printing settings button that is included in the UI of this application. In this printing setup processing, the printer driver for the printing device connected to the PC (a printer A in this example) first displays a UI image for setup, such as the UI image 130 of FIG. 13, on the display device of the PC.

The UI image 130 displays an OK button 131 to store settings made at the time of selection and close the UI image 130 to complete setup, a pull-down menu 132 to select the document paper size, a zoom setup area 133, and a checkbox 134 to be checked when performing poster printing.

In the zoom setup area 133, a radio button 133a to print without zoom (i.e., without changing magnification), a radio button 133b to print at an altered magnification at an enlargement/reduction rate that fits the printing paper size, and a radio button 133c to print at an altered magnification by freely setting the enlargement/reduction rate are displayed. These radio buttons 133a through 133c are designed and configured such that any one of them can be selected.

Furthermore, when the radio button 133b is selected, a pull-down menu 133d to select which size of printing paper to print the document selected on the pull-down menu 132 (an A4 document in this case) may also be displayed. When the radio button 133c is selected, it is possible, for example, to display an input field into which any given enlargement/reduction rate can be input or to display a UI image such as that shown in FIG. 4B as a pop-up image. Moreover, the zoom setup area 133 also includes the display of a checkbox 133e to check whether or not to print the magnification rate information when magnification change processing is performed, such as when either the radio button 133b or 133c is selected.

The user sets up printing from the UI image 130 and then selects the OK button 131 to complete printing setup. The user then selects a print button that is included for the application, or the like, and proceeds to print processing. In this print processing, the printer driver specifies a currently open file as the file to be printed (step S61).

Next, the printer driver performs processing similar to that of steps S32 through S40 and S42 through S44 in FIG. 6 and generates an enlarged/reduced image that incorporates a QR code (steps S62 through S70 and S72 through S74). Note that in the display processing of preview images in step S63, a UI image that includes a preview image 81, a ruler image 82, and magnification change buttons 83 and 84 such as those shown in the UI image 80 of FIG. 8 may be displayed on the display screen of the PC. It is sufficient if this UI image includes a print start button, and it is not necessary to provide a checkbox to checking whether or not to incorporate magnification rate information such as the checkbox 89 because the checkbox 133e exists.

After the processing of step S70, the printer driver generates a print job to print the enlarged/reduced image after incorporating the QR code and sends it to the printing device (the printer A in this example) (step S71). Printed matter whose magnification has been changed and which has incorporated a QR code is thus output from the printer A for the file specified in step S61.

### Fifth Preferred Embodiment

A fifth preferred embodiment of the present invention will be described with reference again to FIG. 9. The present preferred embodiment will be described by mainly focusing on the differences from the second preferred embodiment, but the various application examples described in the second and third preferred embodiments can also be similarly applied.

The printing device according to the present preferred embodiment is a device that omits the magnification rate information incorporation processing in the printing device 1 according to the first preferred embodiment from the printing device 1a according to the second preferred embodiment. Specifically, the printing device 1a according to the present preferred embodiment preferably includes an image processor 11 configured or programmed to perform image processing on the image to be printed, a printer 12 configured to take as input the image on which the image processing has been performed from the image processor 11 and prints it, a document reader 14 configured to optically read a document image printed on a document as the image to be printed, and an information extractor 10a configured to extract magnification rate information that indicates the enlargement/reduction rate from the time of printing at an altered magnification or the inverse of this enlargement/reduction rate from the document image read by the document reader 14.

In addition, when the magnification rate information is extracted by the information extractor 10a, the image processor 11 in the present preferred embodiment generates an original size image as the image processing described above based on the magnification rate information by changing the magnification of the document image such that it becomes the original size of the source document that served as the source when printed incorporating the magnification rate information, and the original size image is output to the printer 12.

Note that the ability to perform document reading processing is preferably a necessity for the printing device according to the present preferred embodiment, but it is not necessary that print processing be executable from external equipment such as a PC (that is, it need not be equipped with a communicator 15). The present preferred embodiment is also capable of being applied to copy machines that only have copy functions.

### Sixth Preferred Embodiment

Next, a sixth preferred embodiment of the present invention will be described. In the first through fifth preferred embodiments, a description was given using the examples of adopting the enlargement/reduction rates with the vertical/horizontal ratio basically being fixed (basic magnification rate setup or magnification rate auto-select) as printing at an altered magnification. However, the present invention is not limited to these preferred embodiments.

In the present preferred embodiment, as was briefly described as the independent vertical/horizontal magnification rate tab 46b in FIG. 4B, printing at an altered magnification preferably is performed by specifying the magnification rate in the vertical direction and the magnification rate in the horizontal direction without fixing a vertical/horizontal ratio.

In this case, when magnification rate information is to be printed, if information is printed which indicates, in the magnification rate information, the magnification rates both in the vertical direction and in the horizontal direction (or magnification rates to return to the original size prior to the printing at an altered magnification) at the time of printing at an altered magnification, then printing is possible at the original size based on these magnification rates even when performing secondary copying. When the vertical/horizontal ratio is not fixed, each of the preferred embodiments described above is capable of being similarly applied by simply changing processing that handles magnification rates for both the vertical and horizontal directions. For example, with regard to the reference space information as well, it is sufficient if information that indicates the space between two points that serves as a reference for each direction, vertical and horizontal, is included, or if not included, it is possible to have the user specify each of them.

### Seventh Preferred Embodiment

A seventh preferred embodiment of the present invention will be described with reference again to FIGS. 1 and 9. In the first through sixth preferred embodiments, a description was given presuming basically that the image to be printed was original size when performing processing to incorporate magnification rate information. However, the present invention is not limited to this and the image to be printed may also be an image that is not original size. The present preferred embodiment will be described below by mainly focusing on the differences from the first and fourth preferred embodiments and from the second and fifth preferred embodiments, but the various application examples described in these preferred embodiments and the various application examples described in the other preferred embodiments can also be similarly applied.

First, the printing device 1 according to the first preferred embodiment and the printer driver according to the fourth preferred embodiment were described using examples in which, when printing the image to be printed at an altered magnification, magnification rate information which is information that indicates the enlargement/reduction rate (or the inverse of the enlargement/reduction rate) from this image to be printed to the enlarged/reduced image is incorporated into the enlarged/reduced image of this image to be printed, and the resulting image is output.

By contrast, the image processor 11 in the printing device 1 according to the present preferred embodiment incorporates magnification rate information into the image to be printed as the image processing and outputs it to the printer 12 when printing of this image to be printed is executed by the printer 12. Furthermore, in the image processing step in the printer driver according to the present preferred embodiment, magnification rate information is incorporated into an image to be printed when executing printing of this image to be printed. In other words, the magnification rate information in the first and fourth preferred embodiments was limited to information that indicates the enlargement/reduction rate at the time of printing at an altered magnification or the inverse of this enlargement/reduction rate, but the magnification rate information in the present preferred embodiment can be information that indicates the enlargement/reduction rate from the original size or the inverse of this enlargement/reduction rate.

As a non-limiting example, a description will be given of the case of creating graphic data of ½ of the original size in a computer aided design (CAD) application on a PC, reading this with the printing device 1 (or from the printer driver of the PC), and then printing this “as is” (at ½ of the original size). In this case, information which indicates that printing is at 0.5× original size (or information which indicates that 2× should be used to produce original size) may be combined with the image to be printed as the magnification rate information. The printed matter that is output in this manner is ½ original size, and the magnification rate information to return to original size is incorporated into the print.

For the printing device 1a according to the second and fifth preferred embodiments, furthermore, examples were given in which when an original size image preferably is generated from magnification rate information, the magnification of a document image is changed such that it becomes the original size of the source document that served as the source at the time of printing with the magnification rate information being incorporated.

By contrast, when the magnification rate information is extracted by the information extractor 10a, the image processor 11 in the printing device 1a according to the present preferred embodiment generates an original size image as the image processing by changing the magnification of the document image such that it becomes the original size based on this magnification rate information.

In the CAD application example described above, the printed matter contained information indicating 0.5× (or information indicating 2×) as the magnification rate information, so an original size duplicate may be output by printing at 2× based on this magnification rate information.

Thus, the present preferred embodiment makes it possible when creating duplicates of printed matter to easily return it to its original size because the magnification rate information printed in combination is deciphered and magnification change processing is executed automatically based on this magnification rate information.

### Other Preferred Embodiments

As can be seen from the flow of the procedures in the printing devices described above as the first through third and fifth through seventh preferred embodiments, the present invention can also take the form of a printing method in a printing device or a program for executing a printing method on the computer of the controller of a printing device.

The printing methods in printing devices according to the first and seventh preferred embodiments preferably include the following image processing steps and printing steps. The image processing step is a step in which the image processor of the printing device incorporates magnification rate information into an image to be printed or the enlarged/reduced image of an image to be printed when executing printing of the image to be printed. The printing step is a step in which the printer of the printing device takes images that have been processed in the image processing step described above as input and prints them. The other application examples are as described in the first through third, sixth, and seventh preferred embodiments, so a description thereof will be omitted. Note that a printing method in the printing device according to the second preferred embodiment combines printing methods corresponding to the first and seventh preferred embodiments with printing method corresponding to the fifth preferred embodiment, which will be described below.

The program (firmware) configured to cause this printing method to be executed on the computer of the controller of a printing device is a processing program that performs processing equivalent to the printer drivers described in the fourth and seventh preferred embodiments on the side of the printing device alone. That is, this program is a program configured to execute the following image processing step and printing instruction step on the computer of the controller. The image processing step is a step in which magnification rate information is incorporated into an image to be printed or the enlarged/reduced image of an image to be printed when executing printing of this image to be printed. The print instruction step is a step in which the printer of the printing device is instructed to print images that have been processed in the image processing step. The other application examples are as described in the first through third, sixth, and seventh preferred embodiments, so a description thereof will be omitted.

The printing methods in printing devices according to the fifth and seventh preferred embodiments have the following document reading steps, information extraction steps, image processing steps, and printing steps. The document reading steps described above are steps in which the document reader of the printing device described above optically reads the document image printed on a document (as the image to be printed). The information extraction steps are steps in which the information extractor of the printing device extracts magnification rate information from the document image read in the document reading steps. The image processing steps are steps in which, when the magnification rate information is extracted in the information extraction steps, the image processor of the printing device generates an original size image based on the magnification rate information by changing the magnification of the document image such that it becomes the original size. The printing steps are steps in which the printer of the printing device takes the original size images as input and prints them. The other application examples are as described in the fifth through seventh preferred embodiments, so a description thereof will be omitted.

The program (firmware) configured to cause the computer of the controller in a printing device to execute this printing method is a program configured to execute the following read instruction step, information extraction step, image processing step, and printing instruction step on the computer of the controller. The read instruction step is a step in which the document reader of the printing device is instructed to optically read the document image printed on the document (as the image to be printed). The information extraction step is a step in which magnification rate information is extracted from the document image that has been read according to the read instruction step described above. The image processing step is a step in which, when the magnification rate information is extracted in the information extraction step, an original size image is generated based on the magnification rate information by changing the magnification of the document image such that it becomes the original size. In other words, the image processing step is a step in which the image processor of the printing device is instructed to generate original size images. The print instruction step is a step in which the printer of the printing device is instructed to print the original size images. The other application examples are as described in the fifth through seventh preferred embodiments, so a description thereof will be omitted.

Moreover, as the flow of the procedure in a printer driver incorporated into a computer was described as the fourth and seventh preferred embodiments, the present invention can take the form of a printing method in which printing is performed with a printing device from a computer.

This printing method preferably includes the following image processing step and printing step. The image processing step is a step in which the image processor in a computer (i.e., the image processing program of a printer driver) incorporates magnification rate information into an image to be printed or the enlarged/reduced image of an image to be printed when executing printing of the image to be printed. The printing step is a step in which the printer of the printing device takes images that have been processed in the image processing step as input and prints them. The other application examples are as described in the fourth, sixth, and seventh preferred embodiments, so a description thereof will be omitted.

In addition, it is also easy to understand forms as program recording media that record the programs of the various forms described above (firmware or printer drivers) on computer-readable recording media (recording media that are not for one-time use). As was described above, a variety of formats of computer can be applied as this computer beyond the ordinary PC, such as a microcomputer that functions as the controller of the printing device, or a programmable ordinary integrated circuit/chipset. Furthermore, this program is not limited to being distributed via portable recording media but can also be distributed over a network such as the Internet or by broadcasting. Reception over a network refers to reception of a program recorded on a storage device such as an external server device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printing device comprising:
an image processor configured or programmed to perform image processing on an image to be printed; and
a printer configured to take the image that has undergone image processing as input from the image processor and print the image; wherein
the image processor is configured or programmed to incorporate magnification rate information into the image to be printed or an enlarged/reduced image of the image to be printed as the image processing and to output a resulting image including the magnification rate information to the printer.

2. The printing device according to claim 1, wherein, in a case in which the magnification rate information is incorporated into the enlarged/reduced image as the image processing, the magnification rate information is information that indicates an enlargement/reduction rate or an inverse of the enlargement/reduction rate when the magnification is changed from the image to be printed to the enlarged/reduced image.

3. The printing device according to claim 1, further comprising a setter configured to set whether or not to print the magnification rate information based on a user operation.

4. The printing device according to claim 1, further comprising:
a document reader configured to optically read a document image printed on a document; and
an information extractor configured to extract the magnification rate information from the document image read by the document reader; wherein
when the magnification rate information is extracted by the information extractor, the image processor generates an original size image as the image processing based on the magnification rate information by changing the magnification of the document image such that the image becomes original size, and outputs a resulting image to the printer.

5. The printing device according to claim 4, wherein the original size image is an image from which the magnification rate information has been eliminated by the image processor.

6. The printing device according to claim 4, wherein
the magnification rate information is printed at a prescribed size defined in advance; and
when the magnification rate information is extracted by the information extractor, the image processor generates the original size image as the image processing based on the magnification rate information and the prescribed size and outputs a resulting image to the printer.

7. The printing device according to claim 1, wherein the magnification rate information is printed as a QR code or a barcode.

8. A printing device comprising:
an image processor configured or programmed to perform image processing on an image to be printed;
a printer configured to take the image that has undergone the image processing as input from the image processor and to print the image;
a document reader configured to optically read a document image printed on a document as the image to be printed; and
an information extractor configured to extract magnification rate information from the document image read by the document reader; wherein
when the magnification rate information is extracted by the information extractor, the image processor generates an original size image as the image processing based on the magnification rate information by changing the magnification of the document image such that the image becomes original size, and outputs a resulting image to the printer.

9. The printing device according to claim 8, wherein, in a case in which the magnification rate information is incorporated into the enlarged/reduced image as the image processing, the magnification rate information is information that indicates an enlargement/reduction rate or an inverse of the enlargement/reduction rate when the magnification is changed from the image to be printed to the enlarged/reduced image.

10. The printing device according to claim 8, further comprising a setter configured to set whether or not to print the magnification rate information based on a user operation.

11. The printing device according to claim 8, wherein the original size image is an image from which the magnification rate information has been eliminated by the image processor.

12. The printing device according to claim 8, wherein
the magnification rate information is printed at a prescribed size defined in advance; and
when the magnification rate information is extracted by the information extractor, the image processor generates the original size image as the image processing based on the magnification rate information and the prescribed size and outputs a resulting image to the printer.

13. The printing device according to claim 8, wherein the magnification rate information is printed as a QR code or a barcode.

14. A printing method comprising:
an image processing step in which, when executing printing of an image to be printed, an image processor incorporates magnification rate information into the image to be printed or an enlarged/reduced image of the image to be printed; and
a printing step in which a printer takes an image that has undergone processing in the image processing step as input and prints the image.

15. A printing method performed on a printing device, comprising:
a document reading step in which a document reader of the printing device optically reads a document image printed on a document;
an information extraction step in which an information extractor of the printing device extracts magnification rate information from the document image read in the document reading step;
an image processing step in which, when the magnification rate information is extracted in the information extraction step, an image processor of the printing device generates an original size image based on the magnification rate information by changing the magnification of the document image such that the image becomes original size; and
a printing step in which a printer of the printing device takes the original size image as input and prints the image.
